(19) United States
(12) Patent Application Publication
(10) Pub. No.: US 2006/0025125 A1
(43) Pub. Date: Feb. 2, 2006

(54) Method and apparatus for processing message in mobile communication service system

(75) Inventors: Sung-Chul Hong, Seongnam-si (KR); Chan-Bok Lee, Seoul (KR); Seung-Il Yoon, Seongnam-si (KR); Hyun-Seok Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/190,064

(22) Filed: Jul. 27, 2005

(30) Foreign Application Priority Data
Jul. 29, 2004 (KR) 2004-59978

(51) Int. Cl. H04Q 7/20

(52) U.S. Cl. 455/422.1; 455/518

(57) ABSTRACT

A method and apparatus for processing a message in a mobile communication service system are provided. When a subscriber requests a Push To Talk (PTT) group communication service in the mobile communication service system, a group request service based on temporary specific information assigned to the corresponding group is generated and transmitted to a called mobile station over a signaling channel.

### CLAIM OF PRIORITY

This application claims the benefit under 35 U.S.C. §119(a) of an application for a METHOD AND APPARATUS FOR PROCESSING MESSAGE IN MOBILE COMMUNICATION SERVICE SYSTEM filed in the Korean Intellectual Property Office on 29 Jul. 2004, assigned Serial No. 2004-59978, the entire disclosure of which is hereby incorporated by reference.

### BACKGROUND OF THE INVENTION

1. Field of the Invention

The present invention relates to a method and apparatus for processing a message in a mobile communication service system. More specifically, the present invention relates to a method and apparatus for processing a message in a mobile communication service system where, in the case of a subscriber requesting a Push-To-Talk (PTT) group communication service to communicate with a plurality of mobile stations simultaneously, a service provision server of a PTT service provision system does not generate a plurality of request messages but rather a unique request message according to address information of each mobile station included in the group and transmits the message to each mobile station in a broadcast scheme so that wired and wireless resources can be used more efficiently.

2. Description of the Related Art

Wireless communication service technology provides a mobile station (MS) with a wireless communication service by constructing a packet network in an existing mobile communication network.

The packet network is comprised of a Packet Data Service Node (PDSN) where an environment is set up to provide data service, and a packet transmission network is used to transmit packets to the MS.

The methods for constructing such a packet transmission network can be generally divided into two schemes: a Universal Mobile Telecommunication System (UMTS) scheme standardized by 3GPP standardization organization in central Europe, and CDMA 2000 standardized by 3GPP2 standardization organization in central North America.

According to CDMA 2000, the packet transmission network can be constructed of a Packet Control Function (PCF) and a Packet Data Serving Node (PDSN) and connected to a Base Station (BS) that wirelessly exchanges CDMA signals with the mobile station.

The PCF manages a state of the mobile station and a buffering function until the packet transmitted from the PDSN is transmitted wirelessly.

Further, the PDSN performs a Network Access Server (NAS) function to set up a Point-to-Point (PPP) session with the mobile station.

That is, the PDSN sets up, maintains, and terminates the PPP session with the mobile station and a logical link to exchange data wirelessly, converts data transmitted from the mobile station into packets, and transmits the packets to an IP network.

In a call-processing procedure for providing the mobile station with wireless communication service in the system for providing wireless communication service, when the PDSN receives a service request message from the mobile station, it sets up the PPP session with the mobile station to provide the service according to Link Control Protocol (LCP), Authentication procedure, and Internet Protocol Control Protocol (IPCP).

The PDSN performs an access authentication procedure based on mobile station-specific information, assigns the mobile station with an IP address, and registers the mobile station-specific information.

Further, the wireless communication service is provided through the PPP session that the PDSN sets up with the PDSN.

The wireless communication service can be a real time multimedia service provided by interlocking the mobile communication network and the IP network, such as a Push-To-Talk (PTT) service, a Push-To-Data (PTD) service, and an Image Message (IM) service. The case where the PTT service is provided will be described below.

FIG. 1 is a block diagram showing an overall network connection structure of a system for providing a PTT service.

Referring to FIG. 1, the system for providing a PTT service comprises a mobile station (MS) 10, a base station (BS) 20, a Packet Control Function (PCF) 30, a Packet Data Serving Node (PDSN) 50, and a service providing server 60.

The mobile station 10 and base station 20 are wirelessly connected with each other, and the base station 20 and the PCF 30, and the PCF 30 and the PDSN 50, are connected with wired connections.

Further, the PDSN 40 is connected to the service providing server 60 through the IP network.

The mobile station 10 is controlled by a user to transmit an SIP-format request message “INVITE” to the base station 20.

The base station 20 transmits the request message received from the mobile station 10, which belongs to a service cell, to the PCF 30, which then transmits the received request message to the PDSN 50.

In the above case, the base station 20 and PCF 30 can be components of the base station system (BSS) 40.

The PDSN 50 sets up a PPP session with the mobile station 10 according to the received request message, converts the request message into an IP packet, and transmits the converted IP packet to the service providing server 60.

The service providing server 60 provides a wireless communication service in response to the received request message.

That is, the service providing server 60 manages the MS-specific information of each mobile station 10 registered in the form of a list or group. And, when recipient address information of the “INVITE” message received from the mobile station 10 is the MS-specific information of a recipient mobile station 10, the service providing server 60 transmits the “INVITE” message to the recipient mobile station 10.

Here, the MS-specific information can correspond to telephone number information, IP address information, or an e-mail address of the mobile station 10.

Meanwhile, when the recipient address information of the “INVITE” message received from the mobile station 10 is group-specific information, the service providing server 60 generates a plurality of “INVITE” messages to be transmitted to each mobile station 10 included in the corresponding group according to the MS-specific information of each mobile station 10, and transmits each “INVITE” message to the corresponding mobile station 10.

Further, the network comprising the base station 20, PCF 30, and PDSN 40 is referred to as an Access Network (AN) that enables the mobile station 10 to access the IP network.

FIG. 2 is a flowchart showing the setup of a voice call in a system for providing general PTT service.

Referring to FIG. 2, a first mobile station 11 is manipulated by a user to generate a request message, that is, an “INVITE” message, based on SIP, and transmits the message to a first base station system (BSS) 41 (S1).

In this case, messages are exchanged between the first mobile station 11 and the first base station system 41 through a Reserved Common Signaling Channel (RCSH) in a Short Data Burst (SDB) scheme, although a Forward Common Signaling Channel (FCSH) in a Short Data Burst (SDB) scheme may be used.

The FCSH can use a Paging channel, a Forwarding common control channel, or the like, and the RCSH can use an Access channel, an Enhanced Access channel, or the like.

Further, the first mobile station 11 can include the group-specific information or the MS-specific information as recipient address information of the “INVITE” message, depending on the user's selection.

The first base station system 41 transmits the “INVITE” message received over the signaling channel (RCSCH) to the service providing server (S2) through the PDSN 40, and the service providing server 60 transmits the “INVITE” message to recipient mobile stations 12-1n using the recipient address information of the received “INVITE” message.

Here, when the recipient address information of the “INVITE” message received from the first mobile station 11 is the group-specific information, the service providing server 60 generates a plurality of “INVITE” messages to be transmitted to each of the mobile stations 12-1n, excluding the first mobile station 11, using the MS-specific information of each of the mobile stations 11 and 12-1n included in the corresponding group (S3).

For example, when the number of the specific information of the mobile stations 11 and 12-1n included in a group corresponding to the group-specific information included in the received “INVITE” message as the recipient address information is ten (10), the service providing server 60 generates 9 “INVITE” messages respectively addressed to 9 mobile stations 11 and 12-1n, excluding the first mobile station 11, which is a caller mobile station.

Further, the service providing server 60 sequentially transmits the “INVITE” message to a second base station system 42 connected to the corresponding mobile stations 12-1n according to address information of the mobile stations 12-1n included as recipient address information in the plurality of generated “INVITE” messages (S4).

The second base station system 42 sequentially transmits the received “INVITE” message to the corresponding mobile stations 12-1n through the signaling channel (FCSCH) according to a SDB scheme (S5).

Each of the mobile stations 12-1n receiving the “INVITE” message generates a “200 ok” response message according to a user's response and transmits the “200 ok” message to the second base station system 42 on the signaling channel (RCSH) (S6). The second base station system 42 transmits the response message to the service providing server 60 through the PDSN 50 (S7).

The service providing server 60 transmits each of the received response messages to the first base station system 41 interlocked with the first mobile station 11 (S8), and the first base station system 41 transmits each of the received response messages to the first mobile station 11 through a traffic channel TCH that is set up (S9).

That is, in the general TPP service providing system, the service request message “INVITE” is exchanged between the mobile station 10 and the base station system 40 through a common signaling channel in SDB format.

At this time, while an “INVITE” message is exchanged through the signaling channel in the case of 1:1 speech scheme where the recipient address information of the “INVITE” message is the MS-specific information, the service providing server 60 generates a plurality of “INVITE” messages according to the MS-specific information of each of the mobile stations 11 and 12-1n included in a group and transmits them through the signaling channel to realize a 1:N speech scheme when the recipient address information of the “INVITE” message is the group-specific information.

Accordingly, the voice call setup time to provide the PTT communication service in the PTT service providing system increases, and a plurality of messages are transmitted through wires connecting the service providing server 60 and the base station system 40 so that wired-resource usage efficiency is reduced.

Further, since the base station system 40 sequentially transmits the plurality of “INVITE” messages over the wireless network, usage efficiency of wireless resources connected to the mobile station 10 is reduced.

### SUMMARY OF THE INVENTION

It is, therefore, an objective of embodiments of the present invention to provide a method and apparatus for processing a message in a mobile communication service system where in case that a Push-To-Talk (PTT) service providing system sets up a voice call based on a 1:N speech scheme according to a subscriber's selection, that is, a service providing server has to setup the voice call in each of group, a voice call of each group can be set up through a request message.

According to an aspect of the embodiments of the present invention, there is provided a mobile communication service system comprising a plurality of groups, wherein each group has at least one mobile station, comprising a service providing server for assigning group identification information to group information including the at least one mobile station, generating a second communication request message including group identification information based on group information included in a first communication request message, and multicasting the second communication request message to each mobile station included in the group information.

According to another aspect of the embodiments of the present invention, there is provided a mobile communication service system, comprising at least one mobile station for transmitting a first communication request message comprising group information according to a user's selection, and generating a response message of a communication request message received during a time slot term based on at least one identification information that is assigned; and a service providing server for assigning each identification information based on address information or group information of the at least one mobile station, generating a second communication request message which includes group identification information corresponding to the group information included in the first communication request message, and multicasting the generated message to the at least one mobile station included in the group information.

According to still another aspect of the embodiments of the present invention, there is provided a mobile communication service system, comprising at least one mobile station for receiving a communication request message during at least one time slot term based on terminal identification information assigned according to address information or group identification information, which is assigned according to group information, and generating a response message when the identification information included in the communication request message is identical to the assigned identification information.

According to yet another aspect of the embodiments of the present invention, there is provided a method for processing a message in a mobile communication service system comprising a group having at least one mobile station, comprising the steps of assigning group identification information based on group information comprising the at least one mobile station; transmitting the group identification information through a registration procedure of the at least one mobile station in the group; generating a second communication request message, which includes group identification information corresponding to the group information, when the group information is included in a first communication request message received from each mobile station in the group; and multicasting the second communication request message to the at least one mobile station in the group included in the group information.

According to yet another aspect of the embodiments of the present invention, there is provided a method for processing a message in a mobile communication service system comprising a plurality of groups, wherein each group has at least one mobile station and a service providing server, comprising the steps of assigning, by the service providing server, group identification information based on group information; confirming, by the at least one mobile station, the group identification information through a registration procedure; transmitting, by the at least one mobile station, a first communication request message including the group information to the service providing server; generating, by the service providing server, a second communication request message including the group identification information based on the group information included in the first communication request message and multicasting the generated second communication request message to the at least one mobile station included in the group information; and transmitting, by the at least one mobile station, a response message to the service providing server according to the group identification information included in the second communication request message.

According to yet another aspect of the embodiments of the present invention, there is provided a method for processing a message in a mobile communication service system comprising a plurality of groups, wherein each group has at least one mobile station, and a service providing server, comprising the steps of confirming, by the at least one mobile station, group identification information corresponding to group information; determining whether the group information based on the group identification information is included in a communication request message received from the service providing server during a time slot term based on the group identification information; and generating a response message and participating in communication with the corresponding group when the communication request message includes the group information based on the group identification information.

According to yet another aspect of the embodiments of the present invention, there is provided a service providing server of a mobile communication system comprising a plurality of groups, wherein each group has at least one mobile station, comprising an address management server for managing address information of the each mobile station and at least one group information; a call control server for assigning group identification information to at least one group information the address management server, generating a second communication request message including the group identification information based on the group information when a first communication request message including the group information is received from the each mobile station and transmitting the second communication request message to the at least one mobile station included in the group information; and at least one proxy server for receiving the first communication request message and multicasting the second communication request message to the corresponding mobile station according to a connection state of the at least one mobile station.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram showing an overall network connection structure of a system for providing a PTT service;

FIG. 2 is a flowchart showing the setup of a voice call in a system for providing a general PTT service;

FIG. 3 is a block diagram of a system for providing a Push To Talk (PTT) service in accordance with an exemplary embodiment of the present invention;

FIG. 4 is a conceptual diagram showing a message flow in accordance with an exemplary embodiment of the present invention;

FIG. 5 is a diagram showing a message structure transmitted by a service providing server in accordance with an exemplary embodiment of the present invention;

FIG. 6 is a diagram showing parameters of the message transmitted over a signaling channel in accordance with an exemplary embodiment of the present invention;

FIG. 7 is a conceptual diagram showing a message generated in accordance with an exemplary embodiment of the present invention.

FIG. 8 is a diagram showing a time slot in which a mobile station receives a message in accordance with an exemplary embodiment of the present invention;

FIG. 9 is a diagram showing a time slot in which a mobile station receives a message in accordance with an exemplary embodiment of the present invention;

FIG. 10 is a flowchart showing a message flow of a mobile communication service system in accordance with an exemplary embodiment of the present invention; and

FIG. 11 is a flowchart showing a signal flow in a message processing method in a system for providing a PTT service in accordance with an exemplary embodiment of the present invention.

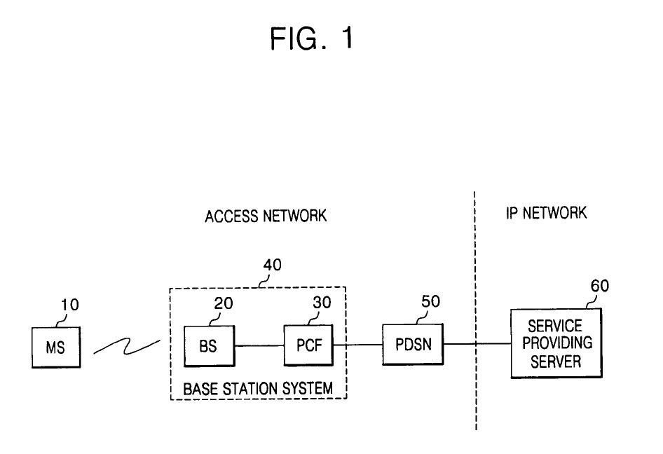

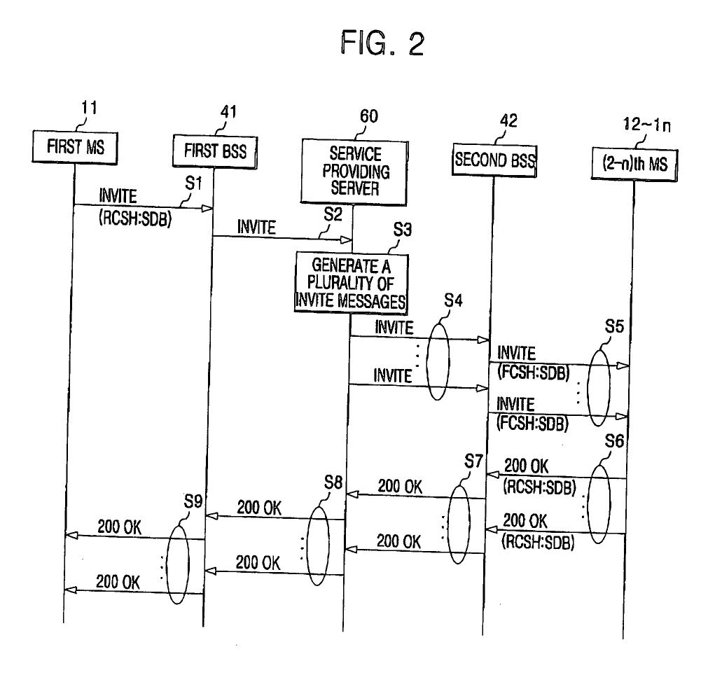

Throughout the drawings, it should be understood that like reference numbers refer to like features, structures, and elements

### DETAILED DESCRIPTION OF EXEMPLARY EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein. Rather, these exemplary embodiments are provided so that this disclosure will be thorough and complete, and will fully convey the scope of the invention to those skilled in the art.

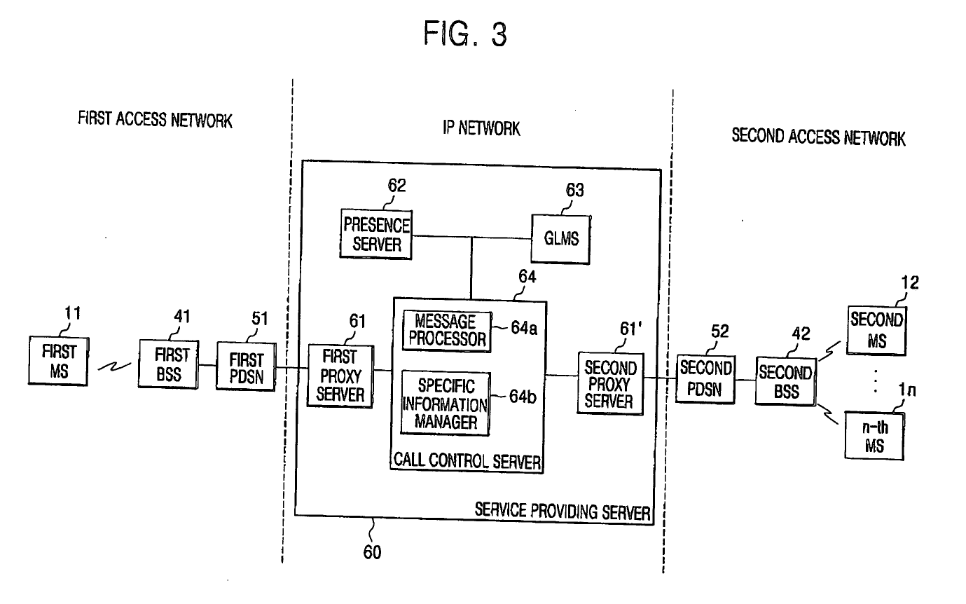

FIG. 3 is a block diagram showing a system for providing a Push To Talk (PTT) service in accordance with an exemplary embodiment of the present invention.

Referring to FIG. 3, mobile stations (MS) 11 and 12 are wirelessly connected to base station systems (BSS) 41 and 42, respectively, and the base station systems 41 and 42 are connected to a service providing server 60 through Packet Data Serving Nodes (PDSNs) 51 and 52.

At this time, the base station systems 41 and 42 preferably include a base station (BS) and a Packet Control Function (PCF), respectively.

The base station systems 41 and 42 transmit a message received over a wireless network to PDSNs 51 and 52 over a wired network, and a message received from the PDSNs 51 and 52 to each of the mobile stations 11 and 12 over the wireless network.

The PCF of the base station systems 41 and 42 processes an SDB header to transmit a message transmitted from the PDSNs 51 and 52 to the mobile stations 11 and 12-1n in a Short Data Burst (SDB) scheme.

Further, the PCF of the base station systems 41 and 42 processes a Generic Route Encapsulation (GRE) header to transmit the message received from the mobile stations 11 and 12-1n in an SDB scheme to the PDSNs 51 and 52.

Meanwhile, the service providing server 60 comprises a plurality of proxy servers 61 and 61′, a presence server 62, a Group List Management Server (GLMS) 63, and a call control server 64, and the call control server 64 preferably comprises a message processor 64a and a specific information manager 64b.

The presence server 62 of the server providing server 60 manages the connection state of the mobile stations 11 and 12-1n connected to the service providing server 60.

That is, the presence server 62 manages state information of log in, log out, idle and busy that are current connection states of each of the mobile stations 11 and 12-1n that are authorized to receive the PTT service through the service providing server 60, and provides the state information of the corresponding mobile stations 11 and 12-1n when it receives a state request message from each of the proxy servers 61 and 61′.

Further, the GLMS 63 manages address information being specific information of the called mobile station set up by subscribers of the mobile stations 11 and 12-1n in the form of a list or group.

For example, the GLMS 63 can manage specific information of other mobile stations registered by the subscriber of the first mobile station 11 in the form of a list or the specific information of the mobile stations 11 and 12-1n included according to the specific information in each group set up by the subscriber. Or, the GLMS 63 can manage them whenever a talk session is set up according to a user's setup.

Further, when the GLMS 63 receives a specific information request message for specific information of the called mobile station from the call control server 64, it provides specific information of the corresponding mobile stations 11 and 12-1n.

At this time, the specific information of the mobile stations 11 and 12-1n managed by the GLMS 63 can be bit information and a user Uniform Resource Identifier (URI) corresponding to information in the form of an e-mail address or e-mail specific information, and the GLMS 63 provides the e-mail specific information or bit information of the corresponding mobile station when it receives the address request message from the call control server 64.

The proxy servers 61 and 61′ receive the IP packet from the PDSNs 51 and 52, respectively, the PDSNs 51 and 52 being connected to the proxies 61 and 61′ through a wired network. That is, when the proxy servers 61 and 61′ receive the communication request message from the mobile stations 11 and 12-1n through the PDSN 51 and 52, they recognize the connection states of the called mobile stations 12-1n from the presence server 62. Subsequently, when the connection state of the called mobile stations 12-1n is an idle state, the proxy servers 61 and 61′ transmit the communication request message to the called mobile stations 12-1n through the corresponding PDSNs 51 and 52 included in the access network AN and set up the talk session between the called mobile stations 12-1n and the calling mobile station 11.

When the mobile stations 11 and 12-1n are connected to and registered in the specific information manager 64b of the call control server 64 through the access network, the specific information manager 64b assigns temporary specific information, that is, terminal identification information based on specific information of the corresponding mobile stations 11 and 12-1n.

Further, when the connected mobile stations 11 and 12-1n are included in the group list, the specific information manager 64b assigns group identification information corresponding to group-specific information including the corresponding mobile stations 11 and 12-1n.

At this time, the terminal identification information can be International Mobile Subscriber Identity (IMSI) information, which can identify each group, or similar a type of information.

The specific information manager 64b transmits the assigned identification information to the mobile stations 11 and 12-1n and the base station systems 41 and 42. That is, each of the mobile stations 11 and 12-1n confirms the identification information assigned from the service providing server 60 through a registration procedure.

Meanwhile, the message processor 64a of the call control server 64 generates the multicast “INVITE” message to be transmitted to the called mobile stations 12-1n according to the recipient address information included in the “INVITE” message that is a request message received from the connected mobile stations 11 and 12-1n, and transmits the multicast “INVITE” message to the corresponding mobile stations 11 and 12-1n through the access network.

For example, a case will be described where the recipient address information included in the received “INVITE” message is the group-specific information, the specific information of the mobile stations 11 and 12-1n is the IP address information, and the first mobile station 11 is included in the same group as the second to n-th mobile stations 12-1n.

The first mobile station 11 sets up the group-specific information as the recipient address information according to the user's selection, generates the group “INVITE” message in which destination address information is set up as the service providing server 60, and transmits the group “INVITE” message to the service providing server 60.

The message processor 64a of the service providing server 64 transmits a specific information request message to the GLMS 63 to confirm the address information of the mobile stations 11 and 12-1n included in the corresponding group-specific information since the recipient address information included in the received group “INVITE” message is group-specific information. Further, the message processor 64a of the service providing server 64 generates the “INVITE” message including address information of the mobile stations 11 and 12-1n transmitted from the GLMS 63 and group identification information that the specific information manager 64b assigned to the corresponding group. Hereinafter, the INVITE message that includes the group identification information and is transmitted to at least one of the mobile stations 11 and 12-1n is referred to as ‘multicast INVITE message’.

Further, the message processor 64a transmits the generated multicast “INVITE” message to the second PDSN 52.

The second PDSN 52 recognizes the address information of the mobile stations 12-1n included in a group corresponding to the group identification information that is included in the received multicast “INVITE” message, and confirms whether or not the state of the traffic channel of the corresponding mobile stations 12-1n is an active state.

Further, when the traffic channels of the mobile stations 12-1n are in the active state, the second PDSN 52 transmits the received multicast “INVITE” message to the corresponding mobile stations 12-1n through the traffic channel of the active state.

Meanwhile, when the traffic channels of the mobile stations 12-1n are not in the active state, the second PDSN 52 transmits the multicast “INVITE” message to the second base station system 42 through a signaling channel A11.

At this time, the second PDSN 52 specifies the SDB scheme in the GRE header in order to transmit the multicast “INVITE” message to the mobile stations 12-1n in the SDB scheme.

The second base station system 42 adds the SDB header to transmit the received multicast “INVITE” message in the SDB scheme, and transmits the SDB header to the mobile stations 12-1n over the signaling channel.

At this time, the second base station system 42 transmits the received multicast “INVITE” message in a time slot period based on the group identification information that is assigned to the group comprising the mobile stations 12-1n.

Such a time slot is a time that is assigned to the mobile stations 11 and 12-1n according to the result of processing the terminal and group identification information assigned to the mobile stations 11 and 12-1n according to a function such as a hash function.

Meanwhile, the mobile stations 12-1n receive the multicast “INVITE” message at a type slot period assigned according the group identification information assigned from the service providing server 60, and transmit a response message of ‘200 OK’ to the second station system 42 according to the subscriber response.

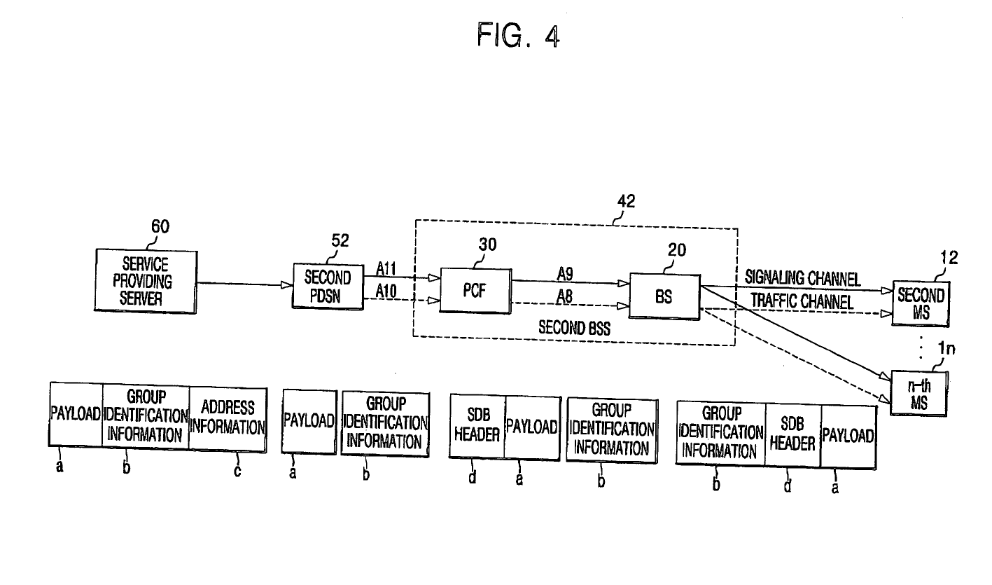

FIG. 4 is a conceptual diagram showing a message flow in accordance with an exemplary embodiment of the present invention.

Referring to FIG. 4, a Radio Packet (RP) interface is set up between the mobile stations 12-1n and a base station 20, and an A8/A9 interface is set up between the base station 20 and the PCF 30, and an A10/A11 interface is set up between the PCF 30 and the second PDSN 52.

The A8 interface and A10 interface are traffic channels to exchange the communication traffic, and the A9 interface and A11 interface are signaling channels to exchange the signaling message.

When the PPP session of the TPP service providing system is in the ACTIVE state, the A8 interface and A10 interface are set up so that the communication traffic can be exchanged.

Further, the RP interface set up in the mobile stations 12-1n and base station 20 can be divided into a traffic channel and a signaling channel.

When the group “INVITE” message is received from the mobile station 11, the message processor 64a of the service providing server 60 confirms the address information of the mobile stations 11 and 12-1n included in the corresponding group from the GLMS 63.

The message processor 64a transmits the multicast “INVITE” message in the form of a packet that comprises a payload specifying that the request message is the “INVITE” message, a field (b) comprising the group identification information assigned to the corresponding group, and a field (c) comprising the address information of the mobile stations 11 and 12-1n included in the corresponding group to the second PDSN 52.

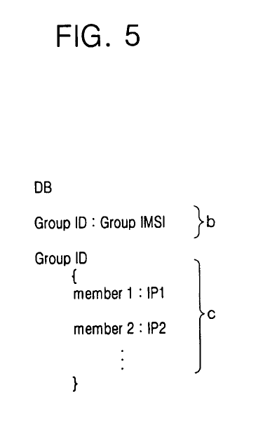

FIG. 5 is a diagram showing a message structure transmitted by a service providing server.

Referring to FIG. 5, the message processor 64a of the service providing server 60 transmits the multicast “INVITE” message comprising group identification information (Group IMSI) (b) of the group corresponding to the recipient address information included in the “INVITE” message received from the mobile station 11 and the multicast “INVITE” message comprising address information (c) of the mobile stations (members) included in the corresponding group, which may or may not include some or all of mobile stations 12-1n, to the second PDSN 52.

Further, as shown in FIG. 4, the second PDSN 52 extracts address information of the mobile stations 11 and 12-1n from the multicast “INVITE” message received from the service providing server 60.

The second PDSN 52 confirms whether the traffic channel state of the mobile stations 12-1n except the first mobile station 11, which is a calling mobile station that is in an active state. Subsequently, the second PDSN 52 transmits the multicast “INVITE” message over the traffic channels A10 and A8 set up with the corresponding mobile station when the traffic channel is in the active state.

Meanwhile, when the traffic channels of the mobile stations 12-1n are not in the active state, the second PDSN 52 transmits the multicast “INVITE” message including the payload (a) and the group identification information (b) to the PCF 30 over the signaling channel A11.

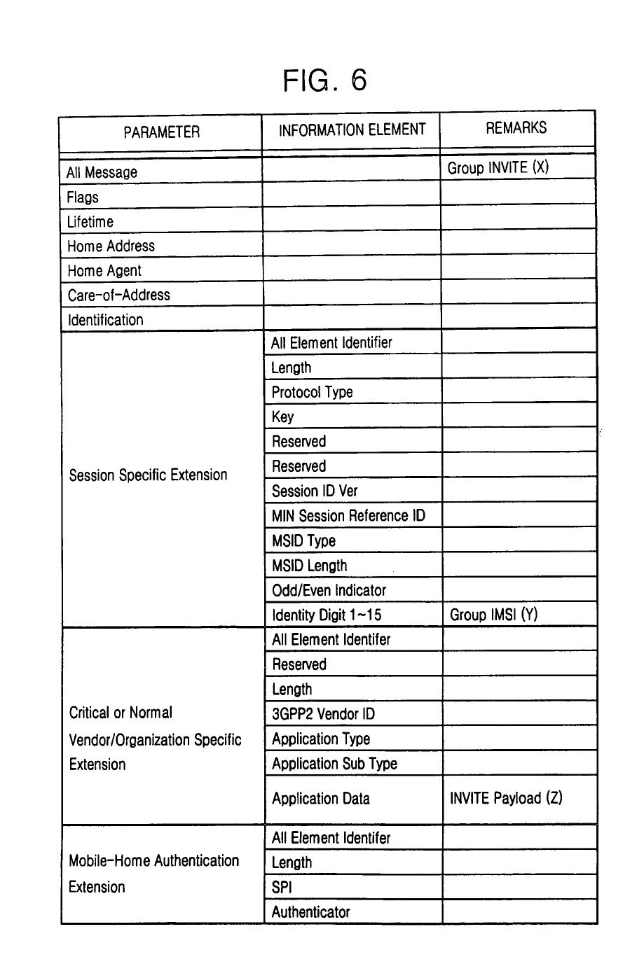

FIG. 6 is a diagram showing parameters of a message transmitted over a signaling channel in accordance with an embodiment of the present invention.

Referring to FIG. 6, the second PDSN 52 can set up the ‘message type’ as a value X indicating a type of a group “INVITE” message, ‘Identity Digit’ as a value Y corresponding to the group identification information assigned according to the group, and ‘Application Data’ as a value Z specifying the “INVITE” message in the parameter of the group “INVITE” messages transmitted over the signaling channel A11.

Meanwhile, the second PDSN 52 specifies the SDB scheme in the GRE header and transmits to the PCF 30 to transmit the multicast “INVITE” message in the SDB scheme.

Further, the PCF 30 adds the SDB header (d) ahead of the payload (a) of the multicast “INVITE” message received over the signaling channel A11 and transmits the message to the base station 20 over the signaling channel A9.

The base station 20 transmits the multicast “INVITE” message including the group identification information (b), SDB header (d) and payload (a) over the signaling channel according to the SDB scheme in the time slot period based on the group identification information included in the received multicast “INVITE” message.

At this time, the reason why the base station 20 includes the group identification information (b) in the multicast “INVITE” message is to discard the multicast “INVITE” message using the corresponding mobile station when a mobile station which is not included in the group receives the multicast “INVITE” message during the corresponding time slot period.

That is, when a mobile station which is not included in the group receives the multicast “INVITE” message and the group identification information (b) included in the multicast “INVITE” message is not identical to the second specific information assigned from the service providing server 60, the received group “INVITE” message is discarded so that the mobile station which is not included in the group does not participate in the group voice call.

Further, the base station 20 can transmit the group “INVITE” message to the mobile stations 12-1n over the signaling channel in the time slot period based on the group identification information.

The mobile stations 12-1n receives the multicast “INVITE” message transmitted through the assigned time slot, generates a response message of ‘200 OK’ according to the subscriber response and transmits the response message to the base station 20 over the signaling channel in the SDB scheme.

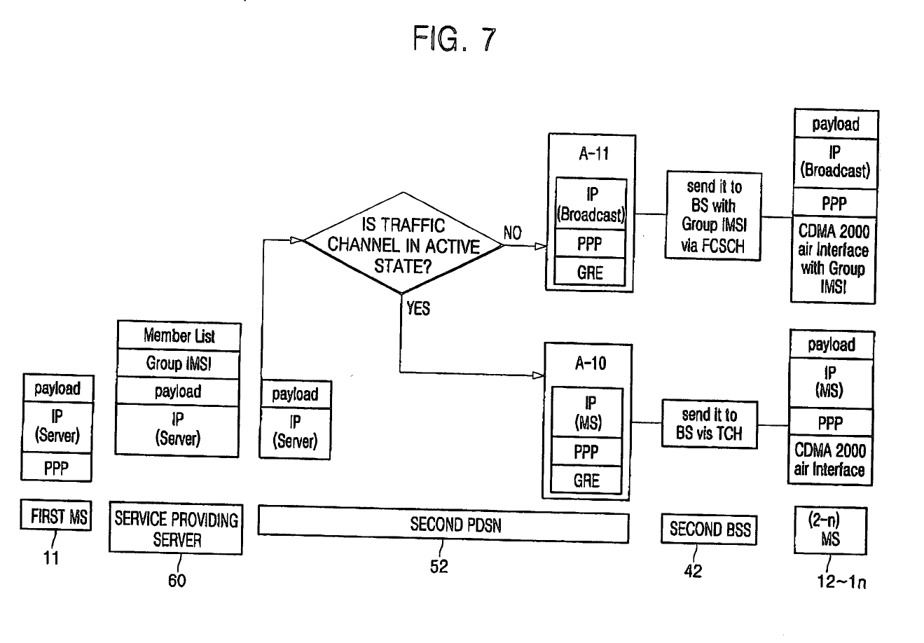

FIG. 7 is a conceptual diagram of a message generated in accordance with an exemplary embodiment of the present invention.

Referring to FIG. 7, the first mobile station 11, which is a calling mobile station, sets up the destination IP address information as IP address information of the service providing server 60 according to the subscriber's selection, specifies the destination IP address information as the “INVITE” message, and transmits the request message including the payload in which the recipient address information is set up as the group-specific information to the service providing server 60 through the Point to Point Protocol (PPP) session.

The service providing server 60 confirms the group identification information assigned to the corresponding group and the address information of the mobile stations 12-1n included in the corresponding group when the group “INVITE” message is received.

The service providing server 60 sets up the destination address information of the multicast “INVITE” message comprising the confirmed group identification information, the address information of the mobile stations 12-1n and the payload as the IP address information of the second PDSN 52 and transmits the set IP address information to the second PDSN 52.

The second PDSN 52 extracts the address information of the mobile stations 12-1n included in the received multicast “INVITE” message, and confirms whether the traffic channels of the mobile stations 12-1n are in the active state.

When the traffic channel of the mobile station is in the active state, the second PDSN 52 sets up the address information of the corresponding mobile station as the destination address information, and transmits the group “INVITE” message to the corresponding mobile station over the traffic channel set up with the PPP session.

Meanwhile, when the traffic channel of the mobile station is not in the active state, the second PDSN 52 sets up the destination address information as broadcast address information, and transmits the multicast “INVITE” message including the group identification information of the corresponding group to the second base station system 42 over the signaling channel A11.

When the second base station system 42 receives the multicast “INVITE” message over the signaling channel A11, it transmits the multicast “INVITE” message to the mobile stations 11 and 12-1n over the signaling channel.

At this time, the second base station system 42 transmits the multicast “INVITE” message during a time slot term assigned according to the result of functionally processing the group identification information assigned to the group including the corresponding mobile stations 11 and 12-1n, and the mobile stations 12-1n receives the multicast “INVITE” message transmitted from the second base station system 42 during the time slot term according to the result of functionally processing the assigned group identification information.

That is, the mobile stations 12-1n receives the multicast “INVITE” message over the traffic channel when the traffic channel is in the active state and the multicast “INVITE” message during the assigned time slot term when the traffic channel is not in the active state.

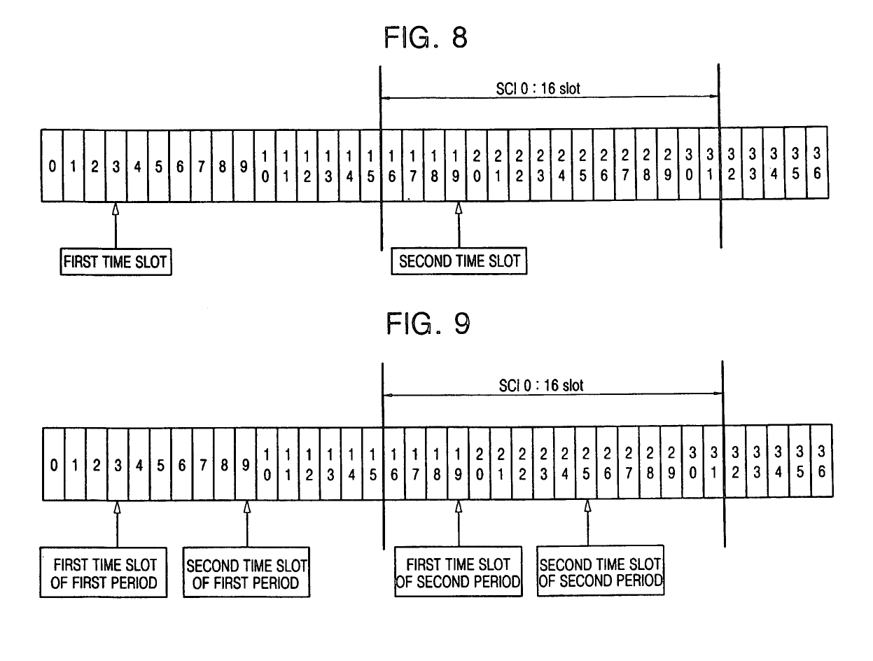

FIG. 8 is a diagram showing a time slot in which a mobile station receives a message according to an embodiment of the present invention.

Referring to FIG. 8, the mobile stations 11 and 12-1n can receive the message during a time slot term according to the result of functionally processing terminal identification information assigned according to the address information from the service providing server 60.

For example, when the time slot period (SCI) is 16, and the time slot assigned by the mobile stations 11 and 12-1n is three (3), the mobile stations receive the message transmitted from the base station systems 41 and 42 during the fourth time slot term of the first period, and the message transmitted from the base station systems 41 and 42 during the 20^{th} time slot term according to the time slot period.

FIG. 9 is a diagram showing a time slot in which a mobile station receives a message according to an embodiment of the present invention.

Referring to FIG. 9, the mobile stations 11 and 12-1n of the present invention receive the message transmitted from the base station systems 41 and 42 during a plurality of time slot terms in a period.

In an example, the mobile stations 11 and 12-1n are assigned the terminal identification information based on the address information from the service providing server 60, and the group identification information based on the specific information of the group.

Further, the mobile stations 11 and 12-1n receive the message transmitted from the base station systems 41 and 42 during the first and second time slot terms based on the result of functionally processing the assigned terminal and group identification information.

That is, when the first time slot assigned based on the address information is three (3) and the second time slot assigned based on the specific information of the group is nine (9), the mobile stations 11 and 12-1n receive the message transmitted during the 6^{th} and 10^{th} time slot terms of the first period and the message transmitted during the 20^{th} and 26^{th} time slot terms based on the time slot period from the base station systems 41 and 42.

Further, when the identification information included in the message received during the second time slot term is identical to the group identification information assigned from the service providing server 60, that is, the group identification information included in the received multicast “INVITE” message is identical to the group identification information assigned from the service providing server 60, the mobile stations 11 and 12-1n transmit a response message of ‘200 OK’ to the service providing server 60 according to the subscriber's selection, and discard the multicast “INVITE” message, otherwise.

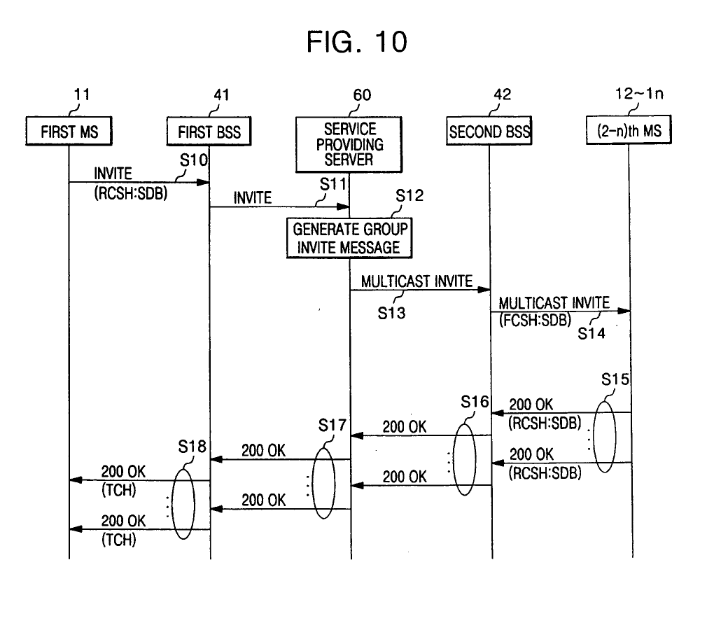

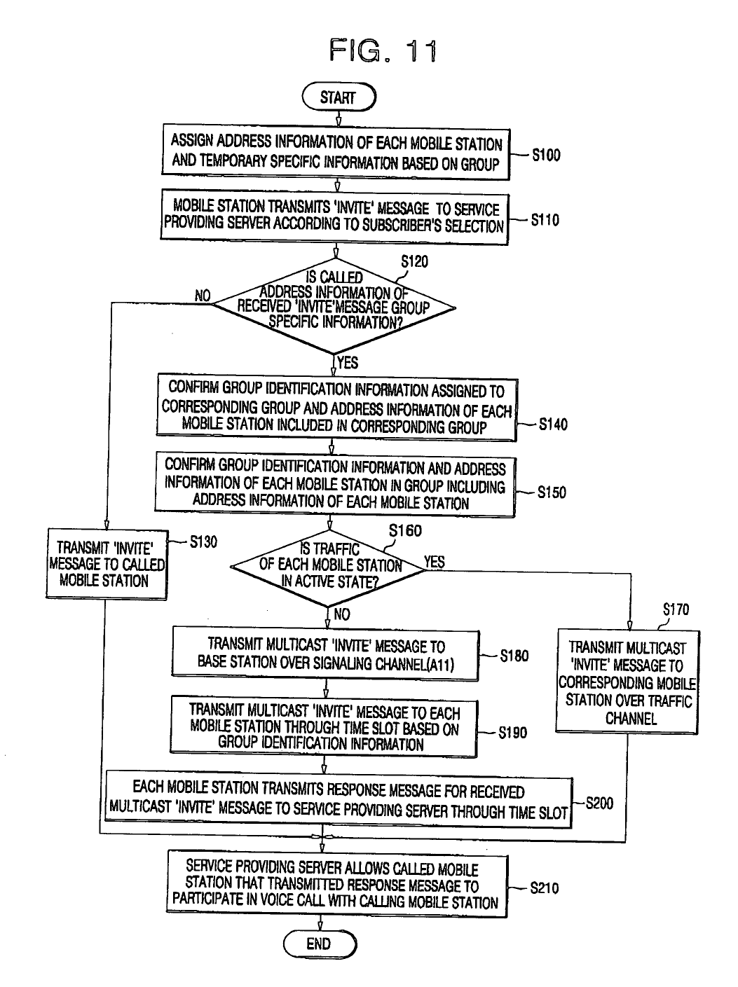

FIG. 10 is a flowchart showing a message flow of a mobile communication service system in accordance with an exemplary embodiment of the present invention.

Referring to FIG. 10, when the first mobile stations 11, which is a calling mobile station, and the called mobile stations 12-1n are connected to each other through the access network and registered in the PTT service providing system, the first mobile station 11 transmits the group “INVITE” message as a request message in which the recipient address information is set up as the group-specific information to the first base station system 41 over a signaling channel (RCSH)(S10).

The first base station system 41 transmits the group “INVITE” message to the service providing server 60 through the first PDSN 51 (S11).

The service providing server 60 confirms whether the recipient address information of the received group “INVITE” message is set up as the group-specific information, and then confirms the second specific information assigned to the corresponding group and the address information of the mobile stations 11 and 12-1n included in the corresponding group.

The service providing server 60 generates the address information of the mobile stations 12-1n except for the address information of the first mobile station 11, which is the calling mobile station, among the address information of the corresponding group, and the multicast “INVITE“message including the group identification information (S12).

The service providing server 60 transmits the generated multicast “INVITE” message to the second base station system 42 connected to the mobile stations 12-1n through the second PDSN 52 (S13).

The second base station system 42 transmits the received multicast “INVITE” message to the mobile stations 12-1n over the signaling channel (FCSH) in the SDB scheme (S14).

At this time, the second PDSN 52 confirms the traffic channel state of the mobile stations 12-1n using the address information of the mobile stations 12-1n included in the received multicast “INVITE” message, and can transmit the multicast “INVITE” message over the traffic channel set up with the corresponding mobile station when there exists a mobile station whose traffic channel is in the active state.

Further, when the mobile stations 12-1n receive the group “INVITE” message over the signaling channel (FCSH), the mobile stations 12-1n generate a response message of ‘200 OK’ according to a subscriber's response, and transmit the response message to the second base station system 42 over the signaling channel (RCDH) in the SDB scheme (S15).

The second base station system 42 transmits the received response message to the service providing server 60 through the second PDSN 52 (S26).

The service providing server 60 transmits the response message received from the mobile stations 12-1n to the first base station system 41 through the first PDSN (51) in order to transmit it to the first mobile station 11, which is the calling mobile station (S17), and the first base station system 41 sequentially transmits the received response message to the mobile station 11 (S18).

Further, the service providing server 60 transmits the response message sequentially 15 received from the called mobile stations 12-1n to the calling mobile station 11, and provides the PTT group communication service by allowing the called mobile stations 12-1n that transmitted the response message for the voice call set up in the calling mobile station 11 to sequentially participate in the communication.

FIG. 11 is a flowchart showing a signal flow in a message processing method in a system for providing a PTT service in accordance with an exemplary embodiment of the present invention.

Referring to FIG. 11, the service providing server 60 of the system for providing a PTT service manages the address information of the mobile stations 11 and 12-1n that is connected through an access network in the form of a list or group.

The service providing server 60 assigns the terminal identification information based on the address information of the mobile stations 11 and 12-1n and the group identification information based on the group-specific information, and transmits the identification information assigned to the mobile stations 11 and 12-1n and the PDSNs 51 and 52 (S100). That is, the mobile stations 11 and 12-1n confirm the identification information assigned from the service providing server 60 through the registration procedure.

The first mobile station 11 generates the “INVITE” message being a request message in which the recipient address information is the group-specific information according to the subscriber's selection, and transmits the “INVITE” message to the service providing server 60 through the access network (S110).

Further, the service providing server 60 confirms whether the recipient address information of the received “INVITE” message is set up as the group-specific information (S120). If the recipient address information is not set up as the group-specific information, the service providing server 60 generates the ‘INVITE’ message in which the address information of the corresponding mobile station is set up as the destination information and transmits the “INVITE” message to the corresponding mobile station (S130).

Meanwhile, in the case where the recipient address information of the received “INVITE” message is the group-specific information, the service providing service 60 confirms the group identification information assigned to the corresponding group and the address information of the mobile stations 12-1n included in the corresponding group (S140).

The service providing server 60 generates the multicast “INVITE” message including the confirmed group identification information and the address information of the mobile stations 12-1n and transmits the message to the second PDSN 52 connected to the called mobile stations 12-1n (S150).

The second PDSN 52 extracts the address information of the mobile stations 12-1n from the received multicast “INVITE” message, and determines whether the traffic channels of the corresponding mobile stations 12-1n are in the active state using the address information of the mobile stations 12-1n (S160).

When there exists a mobile station whose traffic channel is in the active state, the second PDSN 52 transmits the multicast “INVITE” message over the traffic channel set up with the corresponding mobile station (S170).

Alternatively, when the traffic channel of the mobile station is not in the active state, the second PDSN 52 transmits the multicast “INVITE” message to the second base station system 42 connected to the corresponding mobile station over the signaling channel A11 (S180).

The second base station system 42 transmits the received multicast ‘INVITE’ message to each of the mobile stations 12-1n over the signaling channel during the time slot term assigned according to the result of functionally processing the group identification information (S190).

Each of the mobile stations 12-1n receives the multicast ‘INVITE’ message transmitted from the second base station system 42 during the time slot term assigned according to the result of functionally processing the group identification information assigned from the service providing server 60.

Further, each of the mobile stations 12-1n extracts the group identification information included in the received multicast ‘INVITE’ message, and generates a response message according to the subscriber's response and transmits the response message to the service providing server 60 (S200) when the group identification information included in the multicast ‘INVITE’ message is identical to the group identification information assigned from the service providing server 60.

When the service providing server 60 sequentially receives the response message from the called mobile stations 12-1n, it transmits the response message to the calling mobile station 11 and provides the PTT group communication service by allowing the called mobile stations 12-1n that transmitted the response message to participate in the voice call of the calling mobile station 11 (S210).

According to an embodiment of the present invention, when a subscriber requests the PTT group communication service in the system for providing PTT service, a group request message based on temporary specific information assigned to the corresponding group is generated and transmitted to the called mobile station over the signaling channel, so that it is possible to use a signaling channel resource to transmit the communication request message effectively.

Further, it is possible to minimize the time to set up a group voice call by transmitting only one group request message compared to the transmission of N group request messages in the server.

While this invention has been described in connection with exemplary embodiments, it is to be understood that the invention is not limited to the disclosed embodiments, but on the contrary, it is intended to cover variations and modifications within the spirit and the scope of the invention, which is set forth in the appended claims.

What is claimed is:

1. A mobile communication service system comprising a plurality of groups, wherein each group has at least one mobile station, comprising:
a service providing server for assigning group identification information to group information including the at least one mobile station, generating a second communication request message including group identification information based on group information included in a first communication request message, and multicasting the second communication request message to each mobile station in the plurality of groups included in the group information.

2. The system according to claim 1, wherein the service providing server comprises:
a first server for managing address information of the each mobile station in each group of the plurality of groups; and
a second server for assigning the group identification information based on the group information that is managed in the first server and generating the second communication request message including the group identification information based on the group information included in the first communication request message that is received from the at least one mobile station in the identified group.

3. The system according to claim 1, wherein the service providing server transmits terminal identification information based on the address information of each mobile station or the group identification information based on the group information including the at least one mobile station through a registration procedure of the at least one mobile station.

4. The system according to claim 1, wherein the at least one mobile station generates a response message according to a user's selection when receiving a communication request message during a time slot term corresponding to terminal identification information or a time slot term corresponding the group identification information.

5. The system according to claim 1, further comprising a packet data service node (PDSN) for setting up recipient address information of the second communication request message as IP address information of the corresponding mobile station when a traffic channel of the at least one mobile station is in an active state, and transmitting the traffic channel.

6. The system according to claim 5, wherein the PDSN sets up the recipient address information of the second communication request message as broadcast address information and transmits the set address information to the corresponding mobile station over a signaling channel when the traffic channel of the at least one mobile station is not in an active state.

7. The system according to claim 1, further comprising a base station for transmitting the second communication request message to the corresponding mobile station during a time slot term based on the group identification information included in the second communication request message.

8. The system according to claim 1, wherein the terminal identification information is international mobile subscriber identity (IMSI) information.

9. A mobile communication service system, comprising:
at least one mobile station for transmitting a first communication request message including group information according to a user's selection, and generating a response message of a communication request message received during a time slot term based on at least one identification information that is assigned; and
a service providing server for assigning each identification information based on address information or group information of the at least one mobile station, generating a second communication request message which includes group identification information corresponding to the group information included in the first communication request message, and multicasting the generated message to the at least one mobile station included in the group information.

10. A mobile communication service system, comprising:
at least one mobile station for receiving a communication request message during at least one time slot term based on terminal identification information assigned according to address information or group identification information assigned according to group information, and generating a response message when the identification information included in the communication request message is identical to the assigned identification information.

11. A method for processing a message in a mobile communication service system comprising a group having at least one mobile station, comprising the steps of:
assigning group identification information based on group information comprising the at least one mobile station;
transmitting the group identification information through a registration procedure of the each mobile station;
generating a second communication request message which includes group identification information corresponding to the group information when the group information is included in a first communication request message received from the each mobile station; and
multicasting the second communication request message to the at least one mobile station included in the group information.

12. The method according to claim 11, wherein the step of multicasting the second communication request message comprises the steps of:
confirming a state of a traffic channel of the at least one mobile station;
setting up recipient address information of the second communication request message as IP address information of the corresponding mobile station and transmitting through the traffic channel when the traffic channel is in an active state; and
setting up recipient address information of the second communication request message as broadcast address information and transmitting the address information to the corresponding mobile station through a signaling channel when the traffic channel is not in an active state.

13. The method according to claim 11, wherein in the step of multicasting the second communication request message, the second communication request message is transmitted to the corresponding mobile station during a time slot term based on the group identification information according to the group information.

14. The method according to claim 11, further comprising the step of receiving, by the at least one mobile station, the communication request message during at least one time slot term according to the group identification information based on the group information or terminal identification information based on the address information and to generate a response message.

15. A method for processing a message in a mobile communication service system comprising a group, which has at least one mobile station, and a service providing server, comprising the steps of:
assigning, by the service providing server, group identification information based on group information;
confirming, by the at least one mobile station, the group identification information through a registration procedure;
transmitting, by the at least one mobile station, a first communication request message including the group information to the service providing server;
generating, by the service providing server, a second communication request message including the group identification information based on the group information included in the first communication request message and multicasting the generated message to the at least one mobile station included in the group information; and
transmitting, by the at least one mobile station, a response message to the service providing server according to the group identification information included in the second communication request message.

16. The method according to claim 15, further comprising the steps of:
confirming, by the at least one mobile station, whether the communication request message is received during at least one time slot term according to terminal identification information based on address information or the group identification information;
generating the response message when the communication request message is received during the each time slot term; and
discarding the communication request message when the communication request message is not received during the each time slot term.

17. A method for processing a message in a mobile communication service system comprising a group, which has at least one mobile station, and a service providing server, comprising the steps of:
confirming, by the at least one mobile station, group identification information corresponding to group information;
determining whether the group information based on the group identification information is included in a communication request message received from the service providing server during a time slot term based on the group identification information; and
generating a response message and participating in communication of the corresponding group when the communication request message includes the group information based on the group identification information.

18. A service providing server of a mobile communication system comprising a plurality of groups, wherein each group has at least one mobile station, comprising:
an address management server for managing address information of the at least one mobile station and at least one group information;
a call control server for assigning group identification information to each group information the address management server, generating a second communication request message including the group identification information based on the group information when a first communication request message including the group information is received from the each mobile station and transmitting the message to the at least one mobile station included in the group information; and
at least one proxy server for receiving the first communication request message and multicasting the second communication request message to the corresponding mobile station according to a connection state of the at least one mobile station.

19. The server according to claim 18, wherein the call control server comprises a message processor for generating the second communication request message including the group identification information based on the group information that is included in the first communication request message and multicasting the second communication request message to the corresponding mobile station during a time slot term according to the group identification information.
